(19) United States
(12) Patent Application Publication
(10) Pub. No.: US 2002/0144110 A1
(43) Pub. Date: Oct. 3, 2002

(54) Method and apparatus for constructing digital certificates

(76) Inventor: Ramanathan Ramanathan, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/945,913

(22) Filed: Sep. 4, 2001

Related U.S. Application Data
(63) Continuation-in-part of application No. 09/820,110, filed on Mar. 28, 2001.

(51) Int. Cl. H04L 9/00

(52) U.S. Cl. 713/156

(57) ABSTRACT

Constructing digital certificates comprising writing a party's authenticating information and a first digital certificate issuing authorities authenticating information in an electronic document; signing the electronic document to obtain a once signed electronic document; and transmitting the once signed electronic document to a second digital certificate issuing authority to obtain a twice signed electronic document. The first digital certificate issuing authority is a root digital certificate issuing authority, and the second digital certificate issuing authority is a subsidiary digital certificate issuing authority. Alternately, the first digital certificate issuing authority is a subsidiary digital certificate issuing authority, and the second digital certificate issuing authority is a root digital certificate issuing authority.

### CROSS-REFERENCE TO RELATED APPLICATION

This application is a continuation-in-part of Application Ser. No. 09/820,110, filed Mar. 28, 2001, now pending.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The present invention is related to the field of electronic-commerce. In particular, the present invention is related to a method and apparatus for storing digital contracts and digital certificates for long periods of time.

2. Description of the Related Art

Doing business online (e-business) is an accepted business method. However, the Internet as currently structured can be an insecure communications channel. To facilitate e-business, secure encryption methods are available for the transfer of personal information such as home addresses, social security nurnbers, and credit card information. Public key infrastructure (PKI) is well known in the art, and includes a combination of software, encryption technologies, and services that enable business entities and individuals to protect the privacy of their communications and business transactions on the Internet. PKIs integrate digital certificates, public-key cryptography, and certificate authorities into a network security architecture. A typical PKI architecture encompasses the issuances of digital certificates to individual users and servers, end-user enrollment software, integration with corporate certificate directories, and tools for managing, renewing, and revoking certificates.

Rivest-Shamir-Adleman (RSA) is an Internet encryption and authentication system that is commonly used to encrypt and authenticate individuals and entities. This method uses both a private and a public key. Each recipient has a private key that is kept secret and a public key that is published. The sender uses the recipient's public key to encrypt a message. The recipient uses his own private key to decrypt the message. To send an encrypted signature the sender uses his private key to encrypt the signature, and the recipient uses the sender's public key to decrypt the signature and to authenticate the sender. Thus, the private keys are not transmitted and are thereby secure.

A digital certificate is an electronic certificate that establishes one's authenticity, for example, when doing business on the Internet. A digital certificate is issued by a digital certificate issuing authority. The information contained in the digital certificate includes the digital certificate holder's identifying information, such as the digital certificate owner's name, social security number, or bio-identity information. Examples of bio-identity information include digitized iris scans or digitized finger prints. A digital certificate may include a serial number, an expiration date of the certificate, the certificate holder's public key, and the identity of the encryption algorithm used by the owner of the digital certificate. A digital certificate also includes the identity of the encryption algorithm used by the digital certificate issuing authority when signing the digital certificate, and the digital signature of the digital certificate issuing authority so that a recipient may verify the authenticity of the digital certificate. When signing a digital certificate, the digital certificate issuing authority computes a hash value based on the information contained in the digital certificate and encrypts the hash value using the digital certificate issuing authority's private key. The encrypted hash value is then included in the digital certificate. This permits a verification of the identity of the owner of a digital certificate.

In order to verify the identity of the owner of the digital certificate, an interested party obtains the public key of the digital certificate issuing authority from, e.g., the issuing authority's web-site and uses the public key to decrypt the issuing authority's digital signature. By decrypting the digital signature of the digital certificate issuing authority, a hash value is obtained. Next, a hash value of the contents of the digital certificate is obtained, by inserting the contents of the digital certificate into the hash algorithm specified in the digital certificate. If the hash value obtained is equal to the hash value obtained earlier, the identity of the owner of the digital certificate is confirmed.

Digital certificates may be issued by a subsidiary of a root digital certificate issuing authority. However, if the subsidiary digital certificate issuing authority ceases to exist at some point in the future it may be virtually impossible to validate the digital certificate, and hence confirm the identity of the owner of the digital certificate. What is needed, therefore, is a method and apparatus to construct a digital certificate so that the digital certificate may be validated in the event the digital certificate issuing authority ceases to exist.

### BRIEF SUMMARY OF THE DRAWINGS

Examples of the present invention are illustrated in the accompanying drawings. The accompanying drawings, however, do not limit the scope of the present invention. Similar references in the drawings indicate similar elements.

FIG. 1 illustrates a diagram of a digital certificate.

FIG. 2 illustrates a flow diagram for constructing a digital certificate in accordance with one embodiment of the invention wherein an electronic document is signed by a subsidiary followed by a root digital certificate issuing authority.

FIG. 3 illustrates a diagram of a digital certificate in accordance with one embodiment of the invention.

FIG. 4 illustrates a flow diagram for constructing a digital certificate in accordance with one embodiment of the invention wherein an electronic document is signed by a root followed by a subsidiary digital certificate issuing authority.

FIG. 5 illustrates a block diagram of an apparatus that generates a digital certificate in accordance with one embodiment of the invention.

FIG. 6 illustrates a block diagram of a machine accessible medium according to one embodiment of the invention.

### DETAILED DESCRIPTION OF THE INVENTION

Described are embodiments of one or more methods for constructing digital certificates. In the following description, numerous specific details are set forth in order to provide a thorough understanding of the present invention. It will be apparent, however, to one of ordinary skill in the art that the present invention may be practiced without these specific details. In other instances, well-known architectures, steps, and techniques have not been shown to avoid unnecessarily obscuring the present invention. For example, specific details are not provided as to whether the method is implemented in a router, server or gateway, as a software routine, hardware circuit, firmware, or a combination thereof.

Parts of the description will be presented using terminology commonly employed by those skilled in the art to convey the substance of their work to others skilled in the art. Also, parts of the description will be presented in terms of operations performed through the execution of programming instructions. As well understood by those skilled in the art, these operations often take the form of electrical, magnetic, or optical signals capable of being stored, transferred, combined, and otherwise manipulated through, for instance, electrical components.

The invention may utilize a distributed computing environment. In a distributed computing environment, program modules may be physically located in different local and remote memory storage devices. Execution of the program modules may occur locally in a stand-alone manner or remotely in a client/server manner. Examples of such distributed computing environments include local area networks, enterprise-wide computer networks, and the Internet.

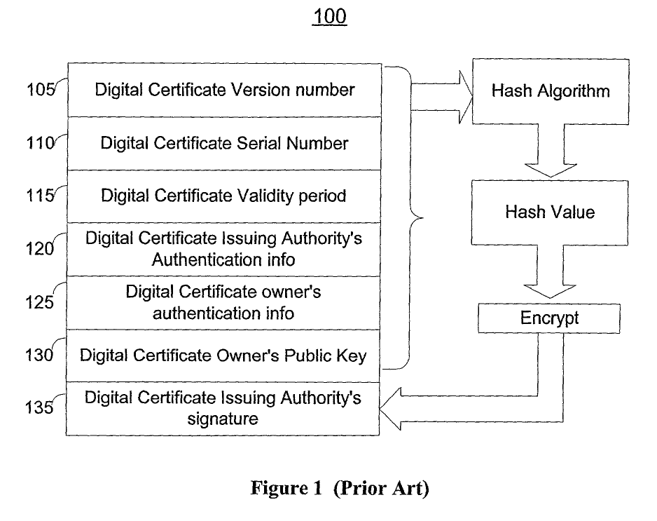

FIG. 1 illustrates a diagram of a digital certificate in accordance with a prior art embodiment. As illustrated in FIG. 1, a digital certificate 100 comprises a digital certificate version number 105, a digital certificate serial number 110, and a validity period 115. Included in the digital certificate is the digital certificate issuing authority's authentication information 120, e.g., the digital certificate issuing authority's name, address, and the identity of the hash algorithm used by the digital certificate issuing authority to sign the digital certificate. A digital certificate also includes the digital certificate owner's authentication information 125, i.e., the owner's name, address, social security number, bio-identity information etc., and the identity of the hash algorithm used by the owner, e.g., when signing electronic documents. In addition, a digital certificate may include the digital certificate owner's public key 130, and the digital certificate issuing authority's signature 135.

If a digital certificate is issued by a subsidiary digital certificate issuing authority, (e.g., the subsidiary of a corporation wherein the principal corporation is the root digital certificate issuing authority, or a department of a government wherein the central government is the root digital certificate issuing authority) and the subsidiary digital certificate issuing authority ceases to exist at some point in the future, the validation of the digital certificate constructed in accordance with prior art embodiments may be virtually impossible. One reason is that the public key of the subsidiary digital certificate issuing authority may be unavailable. However, if the subsidiary digital certificate issuing authority has a grantor or root digital certificate issuing authority that grants the subsidiary digital certificate issuing authority the right to issue digital certificates, it may be possible to validate the issued digital certificate despite the non existence of the subsidiary digital certificate issuing authority. One method for authenticating the issued digital certificate is to include the digital signature of the root digital certificate issuing authority in the digital certificate during the formation of the digital certificate.

With regards to the formation of the digital certificate, various operations will be described as multiple discrete steps performed in turn in a manner that is helpful in understanding the present invention. However, the order of description should not be construed as to imply that these operations are necessarily performed in the order they are presented, or even order dependent. Lastly, repeated usage of the phrase “in one embodiment” does not necessarily refer to the same embodiment, although it may.

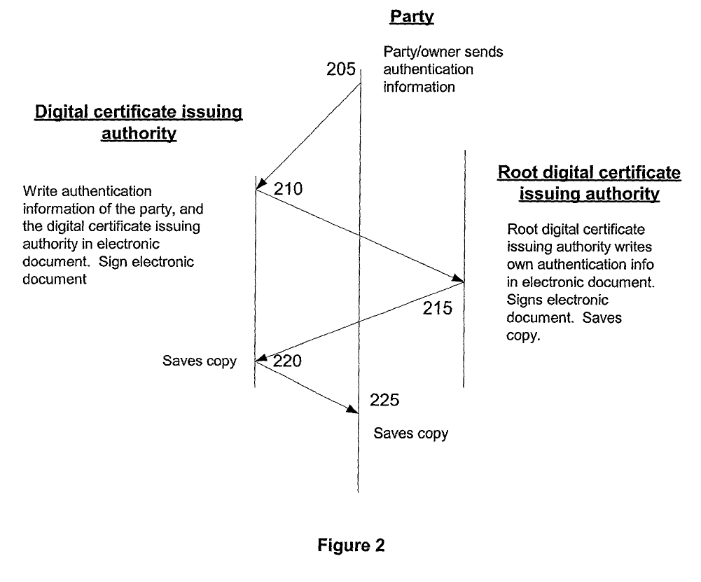

FIG. 2 illustrates a flow diagram for constructing a digital certificate in accordance with one embodiment of the invention wherein an electronic document is signed by a subsidiary digital certificate issuing authority followed by a root digital certificate issuing authority. As FIG. 2 illustrates, at 205, a party or one requesting a digital certificate sends its authentication information such as its name, address, social security number, bio-identity information, etc., to a digital certificate issuing authority e.g., a subsidiary digital certificate issuing authority. Transmissions of data during the formation of the digital certificate may be done via secure connections. Transmissions of data via secure connections are well known in the art and will not be described herein. At 210, the subsidiary digital certificate issuing authority writes the party's authentication information in an electronic document, for example, a text file, along with its own authenticating information. In one embodiment, the authenticating information of the digital certificate issuing authority includes its name, its address, tax identity number, charter number from its certificate of incorporation, public key, and the identity of hash algorithm used in its digital signature. The digital certificate issuing authority may also include other essential information such as the digital certificate version number, the digital certificate serial number, the validity period of the digital certificate, and the digital certificate owner's public key in the electronic document. The digital certificate issuing authority then signs the electronic document. Signing the electronic document includes the digital certificate issuing authority inserting the aforementioned information into the hash algorithm to obtain a hash value. The hash value is then encrypted using the digital certificate issuing authority's private key, and the encrypted hash value is included in the electronic document. The electronic document is then transmitted to the root digital certificate issuing authority.

In one embodiment, there may be one or more subsidiary digital certificate issuing authorities in the chain of digital certificate issuing authorities below the root digital certificate issuing authority that have the authority to issue digital certificates. The electronic document may be signed by one or more subsidiary digital certificate issuing authorities prior to transmitting the electronic document to the root digital certificate issuing authority. For example, in a corporation with multiple subsidiaries, wherein each subsidiary has numerous departments, and the corporation, the subsidiaries and the departments have digital certificate issuing authority, a department after signing the electronic document, may send the electronic document to the subsidiary for signing, and the subsidiary, after signing the electronic document, sends the electronic document to the corporation for signing. On receiving the electronic document with the digital signature of the subsidiary digital certificate issuing authority, at 215, the root digital certificate issuing authority includes its authentication information, e.g., its name, address, tax identity number, charter number from its certificate of incorporation, and identity of the hash algorithm it uses to sign the digital certificate in the electronic document. The root digital certificate issuing authority then signs the electronic document to form a digital certificate. Included in the signature of the root digital certificate issuing authority is a part or all of the information received from the subsidiary digital certificate issuing authority, as well as the authenticating information of the root digital certificate issuing authority. After signing the digital certificate, the root digital certificate issuing authority transmits the digital certificate. In one embodiment the root digital certificate issuing authority may transmit the digital certificate to the party as well as to the subsidiary digital certificate issuing authority. On receiving the digital certificate, at 220, the subsidiary digital certificate issuing authority may save a copy of the digital certificate prior to transmitting the digital certificate to the requesting party at 225.

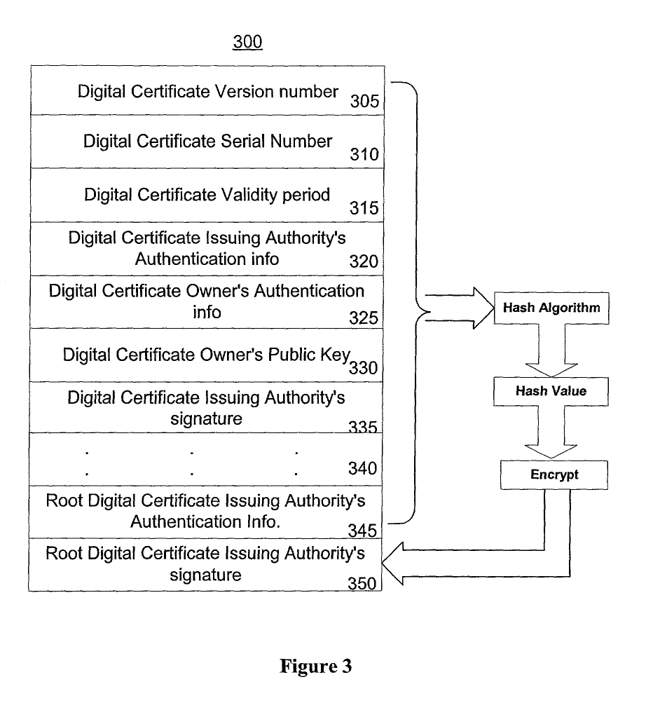

FIG. 3 illustrates a block diagram of a digital certificate, 300, in accordance with one embodiment of the invention. As FIG. 3 illustrates, at 305-315, the digital certificate includes the digital certificate version number, the digital certificate serial number and the validity period of the digital certificate, if any. At 320, the digital certificate contains the subsidiary digital certificate issuing authority's authentication information, e.g., its name, its address, tax identity number, charter number from its certificate of incorporation, and the identity of the hash algorithm it uses in its digital signature. At 325, the digital certificate contains the digital certificate owner's authentication information, e.g., name, address, social security number, bio identity information, etc., including the identity of the hash algorithm used in the owners digital signature. At 330, the digital certificate owner's (i.e., the party requesting the digital certificate) public key may be included in the digital certificate. At 335, the digital certificate contains the subsidiary digital certificate issuing authority's signature. At 340, if more than one subsidiary digital certificate issuing authority exists in the chain of digital certificate issuing authorities, then one or more subsidiary digital certificate issuing authority's authentication information and signature may be included in the digital certificate. At 345, the digital certificate includes the authentication information of the root digital certificate issuing authority, e.g., the root digital certificate issuing authority's name and address, the identity of the hash algorithm the root digital certificate issuing authority uses in its digital signature etc., and at 350 the digital certificate includes the signature of the root digital certificate issuing authority.

In the digital certificate disclosed above, if the subsidiary digital certificate issuing authority ceases to exist at some point in the future, the root digital certificate issuing authority's signature and authentication information that is available in the digital certificate and may be used to validate the digital certificate. For example, using the hash algorithm identified in the root digital certificate authentication information, the contents of the electronic document received by the root digital certificate issuing authority during the creation of the digital certificate may be input in the hash algorithm to obtain a hash value. Next, the root digital certificate issuing authority's public key is obtained, e.g., from the root digital certificate issuing authority's web site, and is used to decrypt the encrypted signature of the root digital certificate issuing authority that is included in the digital certificate. If the two hash values match then the digital certificate is validated.

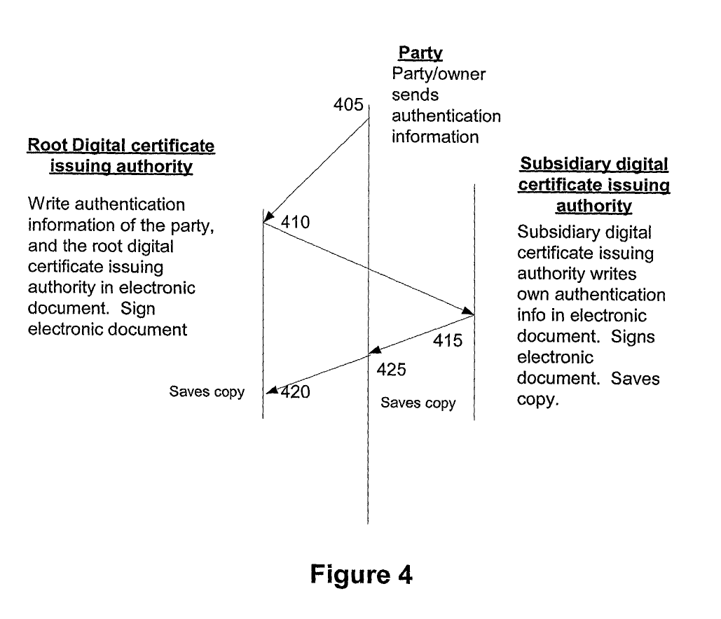

FIG. 4 illustrates a flow diagram for constructing a digital certificate in accordance with one embodiment of the invention wherein an electronic document is signed by a root digital certificate issuing authority followed by a subsidiary digital certificate issuing authority. As FIG. 4 illustrates, at 405, a party or one requesting a digital certificate sends its authentication information such as its name, address, social security number, bio-identity information, etc., to the root digital certificate issuing authority. Alternately, the party may include its authentication information in an electronic document (e.g., a text file, or a digital certificate template) and send the electronic document to the root digital certificate issuing authority. At 410, the root digital certificate issuing authority writes the party's authentication information in the received electronic document, or may generate its own electronic document, and write its own authentication information in the electronic document. In one embodiment, the authenticating information of the root digital certificate issuing authority includes its name, its address, tax identity number, charter number from its certificate of incorporation, its public key, and the identity of the hash algorithm used in its digital signature. The root digital certificate issuing authority may also include other essential information such as the digital certificate version number, the digital certificate serial number, the validity period of the digital certificate, and the digital certificate owner's public key in the electronic document. The root digital certificate issuing authority then signs the electronic document.

After signing the electronic document the root digital certificate issuing authority transmits the electronic document to a subsidiary digital certificate issuing authority and/or to the party requesting the digital certificate. On receiving the electronic document, at 415, either from the root digital certificate issuing authority or from the party requesting the digital certificate, the subsidiary digital certificate issuing authority includes its own authentication information e.g., its name, address, tax identity number, charter number from its certificate of incorporation, public key, and identity of the hash algorithm it uses to sign the digital certificate in the electronic document. The subsidiary digital certificate issuing authority then signs the electronic document to form a digital certificate. After forming the digital certificate, the subsidiary digital certificate issuing authority may save a copy of the digital certificate, and transmit the same to the requesting party. Alternately, the subsidiary digital certificate issuing authority may after signing the electronic document transmit the signed electronic document to other subsidiary digital certificate issuing authorities, in the chain of digital certificate issuing authorities, for the other subsidiaries signatures. The same may be done by the requesting party, after the party receives the signed electronic document from the subsidiary.

In the digital certificate formed in accordance with FIG. 4, if the subsidiary digital certificate issuing authority ceases to exist at some point in the future, the root digital certificate issuing authority's signature and authentication information that is available in the digital certificate and may be used to validate the digital certificate.

It should be understood that the programs, processes, method, etc., described herein are not related or limited to any particular computer or apparatus nor are they related or limited to any particular communication network architecture. Rather, various types of general purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory such as read only memory.

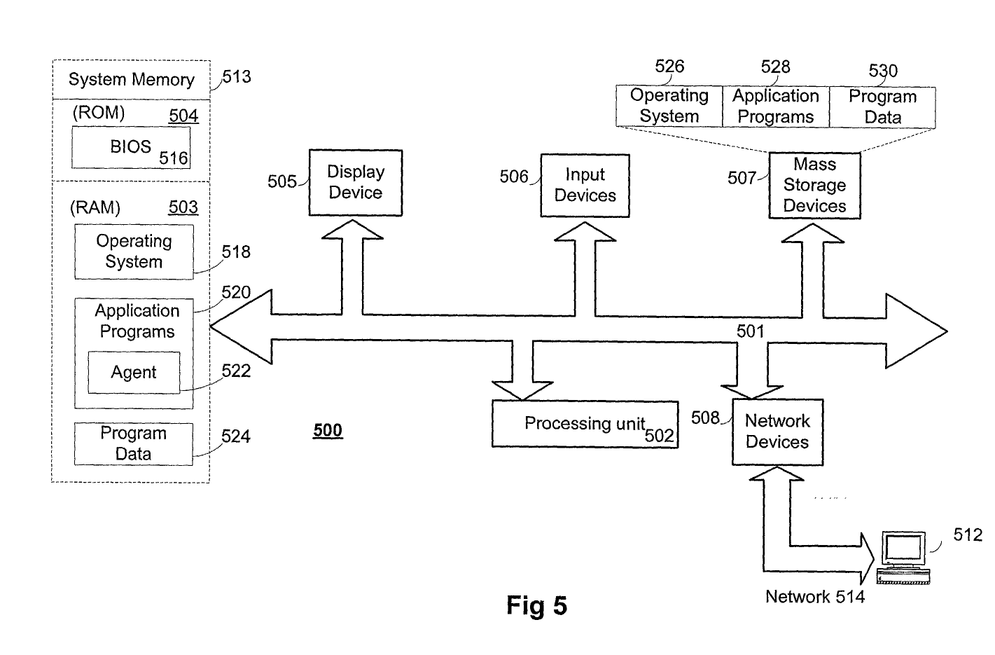

FIG. 5 illustrates a typical computer system 500 in which the present invention operates. The computer system is used for, creating digital certificates. One embodiment of the present invention is implemented using personal computer (PC) architecture. It will be apparent to those of ordinary skill in the art that alternative computer system architectures or other processor, programmable or electronic-based devices may also be employed.

In general, the computer systems illustrated by FIG. 5 includes a processing unit 502 coupled through abus 501 to a system memory 513. System memory 513 comprises a read only memory (ROM) 504, and a random access memory (RAM) 503. ROM 504 comprises Basic Input Output System (BIOS) 516, and RAM 503 comprises operating system 503, Application programs 520, agent 522, and program data 524. Agent 522 comprises the executable programs that generate digital certificates. In particular, agent 522 comprises software programs that generate and receive requests for digital certificates. In one embodiment, the agent 522 includes the necessary authenticating information, (e.g., the name, address, tax identity number, charter number, public key, and identity of the hash algorithm used in the digital signature) of the certificate issuing authority in an electronic document and signs the electronic document. When signing the electronic document agent 522 inserts authenticating information into the hash algorithm identified in the electronic document to obtain a hash value. The hash value is then encrypted using e.g., the digital certificate issuing authority's private key, and the encrypted hash value is included in the electronic document.

Computer system 500 includes mass storage device 507, Input devices 506 and display device 505 coupled to processing unit 502 via bus 501. Mass storage device 507 represents a persistent data storage device, such as a floppy disk drive, fixed disk drive (e.g., magnetic, optical, magneto-optical, or the like), or streaming tape drive. Mass storage device stores Program data 530, application programs 528, and operating system 526. Application programs 528 may include agent software 22. Processing unit 502 may be any of a wide variety of general purpose processors or microprocessors (such as the Pentium® processor manufactured by Intel® Corporation), a special purpose processor, or even a specifically programmed logic device. In one embodiment, the processing unit 502 is operable to receive instructions which, when executed by the processing unit, causes the processing unit to receive a once signed electronic document from a first digital certificate issuing authority (e.g., a root or a subsidiary digital certificate issuing authority), to write a second digital certificate issuing authority's (e.g., a root or a subsidiary digital certificate issuing authority) authenticating information in the once signed electronic document, and to sign the once signed electronic document to form a twice signed electronic document. Processing unit 502 may then transmit the twice signed electronic document (e.g., to a root or a subsidiary digital certificate issuing authority).

Display device 505 provides graphical output for computer system 500. Input devices 506 such as a keyboard or mouse are coupled to bus 501 for communicating information and command selections to processor 502. Also coupled to processor 502 through bus 501 are one or more network devices 508 that can be used to control and transfer data to electronic devices (printers, other computers, etc.) connected to computer 500. Network devices 508 also connect computer system 500 to a network, and may include Ethernet devices, phone jacks and satellite links. It will be apparent to one of ordinary skill in the art that other network devices may also be utilized.

One embodiment of the invention may be stored entirely as a software product on mass storage 507. Another embodiment of the invention may be embedded in a hardware product (not shown), for example, in a printed circuit board, in a special purpose processor, or in a specifically programmed logic device communicatively coupled to bus 501. Still other embodiments of the invention may be implemented partially as a software product and partially as a hardware product.

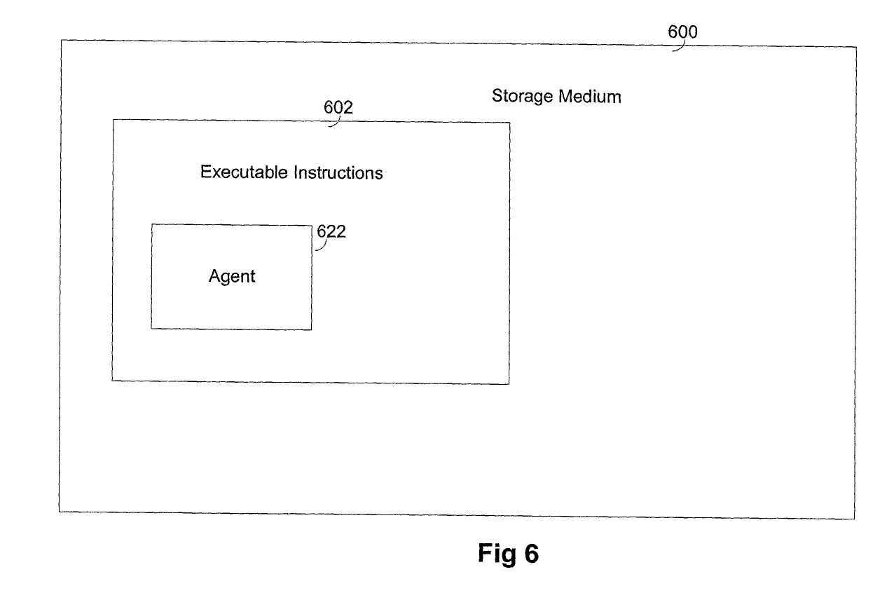

FIG. 6 illustrates one embodiment of the invention stored on a machine-accessible medium. Embodiments of the invention may be represented as a software product stored on a machine-accessible medium 600 (also referred to as a computer-accessible medium or a processor-accessible medium). The machine-accessible medium 600 may be any type of magnetic, optical, or electrical storage medium including a diskette, CD-ROM, memory device (volatile or non-volatile), or similar storage mechanism. The machine-accessible medium may contain various sets of instructions 602, code sequences, configuration information, or other data. Those of ordinary skill in the art will appreciate that other instructions and operations necessary to implement the described invention may also be stored on the machine-accessible medium.

The machine-accessible medium comprises instructions, incorporated in agent 622, that when executed by a machine causes the machine to perform operations comprising writing a party's authenticating information and a first digital certificate issuing authorities authenticating information in an electronic document; signing the electronic document to obtain a once signed electronic document; and transmitting the once signed electronic document to a second digital certificate issuing authority to obtain a twice signed electronic document. The machine-accessible medium includes further instructions to sign the electronic document to obtain a once signed electronic document, wherein signing the electronic document comprises obtaining a hash value by inserting the contents of the electronic document into a hash algorithm and encrypting the hash value using the first digital certificate issuing authority's private key. The machine-accessible medium also includes instructions for storing the encrypted hash value in the electronic document.

Thus a method and apparatus have been disclosed for constructing digital certificates so that digital certificates may be validated even if the digital certificate issuing authority ceases to exist. While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A method comprising:
writing a party's authenticating information and a first digital certificate issuing authority's authenticating information in an electronic document;
signing the electronic document to obtain a once signed electronic document; and
transmitting the once signed electronic document to a second digital certificate issuing authority to obtain a twice signed electronic document.

2. The method of claim 1, wherein the first digital certificate issuing authority is a root digital certificate issuing authority, and the second digital certificate issuing authority is a subsidiary digital certificate issuing authority.

3. The method of claim 2 wherein the first digital certificate issuing authority is a subsidiary digital certificate issuing authority, and the second digital certificate issuing authority is a root digital certificate issuing authority.

4. The method of claim 1 wherein signing the electronic document to obtain a once signed electronic document comprises:
obtaining a hash value using contents of the electronic document as input to a hash algorithm;
encrypting the hash value using the first digital certificate issuing authority's private key; and
writing the encrypted hash value in the electronic document.

5. The method of claim 1 wherein obtaining a twice signed electronic document comprises receiving from the second digital certificate issuing authority a twice signed electronic document.

6. The method of claim 5, wherein the twice signed electronic document comprises:
inserting the second digital certificate issuing authorities authenticating information in the once signed electronic document,
obtaining a hash value using the contents of the electronic document as input to a hash algorithm;
encrypting the hash value using the second digital certificate issuing authority's private key; and
writing the encrypted hash value in the electronic document.

7. The method of claim 6 wherein obtaining a hash value using contents of the electronic document as input to a hash algorithm comprises
using the party's authenticating information;
using the first digital certificate issuing authority's authenticating information; using the digital signature of the first digital certificate issuing authority; and using the second digital certificate issuing authority's authenticating information as input to a hash algorithm.

8. A computer system comprising:
a bus;
a data storage device coupled to said bus; and
a processor coupled to said data storage device, said processor operable to receive instructions which, when executed by the processor, causes the processor
to write a party's authenticating information and a first digital certificate issuing authority's authenticating information in an electronic document;
to sign the electronic document to obtain a once signed electronic document; and
to transmit the once signed electronic document to a second digital certificate issuing authority to obtain a twice signed electronic document.

9. The computer system of claim 8, wherein the first digital certificate issuing authority is a root digital certificate issuing authority, and the second digital certificate issuing authority is a subsidiary digital certificate issuing authority.

10. The computer system of claim 8 wherein the first digital certificate issuing authority is a subsidiary digital certificate issuing authority, and the second digital certificate issuing authority is a root digital certificate issuing authority.

11. The computer system as in claim 8, wherein the instructions which, when executed by the processor, causes the processor to sign the electronic document to obtain a once signed electronic document comprises the processor to:
obtain a hash value using the contents of the electronic document as input to a hash algorithm;
encrypt the hash value using the first digital certificate issuing authority's private key; and
write the encrypted hash value in the electronic document.

12. A computer system as in claim 8 wherein the instructions which, when executed by the processor, causes the processor to obtain a twice signed electronic document comprises the processor to receive from the second digital certificate issuing authority the twice signed electronic document.

13. An article of manufacture comprising:
a machine-accessible medium including instructions that, when executed by a machine, causes the machine to perform operations comprising
writing a party's authenticating information and a first digital certificate issuing authorities authenticating information in an electronic document;
signing the electronic document to obtain a once signed electronic document; and
transmitting the once signed electronic document to a second digital certificate issuing authority to obtain a twice signed electronic document.

14. The article of manufacture as in claim 13, wherein the first digital certificate issuing authority is a root digital certificate issuing authority, and the second digital certificate issuing authority is a subsidiary digital certificate issuing authority.

15. The article of manufacture as in claim 13, wherein the first digital certificate issuing authority is a subsidiar y digital certificate issuing authority, and the second digital certificate issuing authority is a root digital certificate issuing authority.

16. An article of manufacture as in claim 13 wherein said instructions for signing the electronic document to obtain a once signed electronic document comprises further instructions for:
obtaining a hash value using contents of the electronic document as input to a hash algorithm;
encrypting the hash value using the first digital certificate issuing authority's private key; and
writing the encrypted hash value in the electronic document.

17. An article of manufacture as in claim 13 wherein said instructions for obtaining a twice signed electronic document comprises further instructions for
inserting the second digital certificate issuing authorities authenticating information in the once signed electronic document;
obtaining a hash value using contents of the electronic document as input to a hash algorithm;
encrypting the hash value using the second digital certificate issuing authority's private key; and
writing the encrypted hash value in the electronic document.

18. An article of manufacture as in claim 13 wherein said instructions for obtaining a hash value using contents of the electronic document as input to a hash algorithm comprises further instructions for
using the party's authenticating information;
using the first digital certificate issuing authorities authenticating information;
using the digital signature of the first digital certificate issuing authority; and
using the second digital certificate issuing authority's authenticating information as input to a hash algorithm.

19. A method comprising:
receiving a once signed electronic document from a first digital certificate issuing authority;
writing a second digital certificate issuing authority's authenticating information in the once signed electronic document;
signing the once signed electronic document to form a twice signed electronic document; and
transmitting the twice signed electronic document.

20. The method of claim 19, wherein the first digital certificate issuing authority is a root digital certificate issuing authority, and the second digital certificate issuing authority is a subsidiary digital certificate issuing authority.

21. The method of claim 19, wherein the first digital certificate issuing authority is a subsidiary digital certificate issuing authority, and the second digital certificate issuing authority is a root digital certificate issuing authority.

22. The method of claim 19 wherein signing the once signed electronic document to form a twice signed electronic document comprises:
obtaining a hash value using contents of the once signed electronic document and using the digital certificate issuing authority's authenticating information as input to a hash algorithm;
encrypting the hash value using the digital certificate issuing authority's private key; and
writing the encrypted hash value in the electronic document.

23. A computer system comprising:
a bus;
a data storage device coupled to said bus; and
a processor coupled to said data storage device, said processor operable to receive instructions which, when executed by the processor, causes the processor
to receive a once signed electronic document from a first digital certificate issuing authority;
to write a second digital certificate issuing authority's authenticating information in the once signed electronic document;
to sign the once signed electronic document to form a twice signed electronic document; and
to transmit the twice signed electronic document.

24. The computer system of claim 23, wherein the first digital certificate issuing authority is a root digital certificate issuing authority, and the second digital certificate issuing authority is a subsidiary digital certificate issuing authority.

25. The method of claim 23, wherein the first digital certificate issuing authority is a subsidiary digital certificate issuing authority, and the second digital certificate issuing authority is a root digital certificate issuing authority.

26. A computer system as in claim 23 wherein the instructions which, when executed by the processor, causes the processor to sign the once signed electronic document to form a twice signed electronic document comprises the processor to
obtain a hash value using contents of the once signed electronic document and using the digital certificate issuing authority's authenticating information as input to a hash algorithm;
encrypt the hash value using the digital certificate issuing authority's private key; and
write the encrypted hash value in the electronic document.

27. An article of manufacture comprising:
a machine-accessible medium including instructions that, when executed by a machine, causes the machine to perform operations comprising receiving a once signed electronic document from a first digital certificate issuing authority;
writing a second digital certificate issuing authority's authenticating information in the once signed electronic document;
signing the once signed electronic document to form a twice signed electronic document; and
transmitting the twice signed electronic document.

28. The article of manufacture of claim 27, wherein the first digital certificate issuing authority is a root digital certificate issuing authority, and the second digital certificate issuing authority is a subsidiary digital certificate issuing authority.

29. The article of manufacture of claim 27, wherein the first digital certificate issuing authority is a subsidiary digital certificate issuing authority, and the second digital certificate issuing authority is a root digital certificate issuing authority.

30. An article of manufacture as in claim 27 wherein said instructions for signing the once signed electronic document to form a twice signed electronic document comprises further instructions for
obtaining a hash value using contents of the once signed electronic document and using the second digital certificate issuing authority's authenticating information as input to a hash algorithm;
encrypting the hash value using the digital certificate issuing authority's private key; and
writing the encrypted hash value in the electronic document.
